(19) United States
(12) Patent Application Publication
(10) Pub. No.: US 2020/0151732 A1
(43) Pub. Date: May 14, 2020

(54) SYSTEM AND METHOD FOR CLASSIFYING EVENTS TO FACILITATE STORAGE AND RETRIEVAL IN AN EVENT-DRIVEN COMPUTING SYSTEM

(71) Applicant: Zendesk, Inc., San Francisco, CA (US)

(72) Inventors: Cheng Ying Tang, San Francisco, CA (US); Mate T. Rauscher, Burlingame, CA (US)

(73) Assignee: Zendesk, Inc., San Francisco, CA (US)

(21) Appl. No.: 16/183,756

(22) Filed: Nov. 8, 2018

(51) Int. Cl. G06Q 30/00; G06F 17/30

(52) U.S. Cl. CPC G06Q 30/016; G06F 17/30477; G06F 17/30339

(57) ABSTRACT

The disclosed embodiments relate to a system that manages how events are stored and retrieved in an event-driven computing system. During operation, the system obtains an event from a primary events table in the event-driven computing system, wherein the event is associated with a specific event type. Next, the system calculates an importance score for the event based on a rarity of the specific event type and an age of the event. If the importance score falls below a threshold, the system moves the event to a secondary events table, wherein the primary events table is provisioned with superior throughput capacity than the secondary events table, whereby the primary events table facilitates faster queries than the secondary events table.

### BACKGROUND

### Field

The disclosed embodiments generally relate to the design of event-driven computing systems. More specifically, the disclosed embodiments relate to a system that assigns events to different classes of storage to facilitate subsequent query operations involving the events in an event-driven computing system.

### Related Art

Event-driven architectures are increasingly being used to produce highly scalable software systems. Event-driven systems are comprised of highly decoupled event-processing modules, which asynchronously generate, receive and process event notifications. In general, an event-driven architecture facilitates the production, detection and consumption of “events” and associated responses. An event-driven architecture includes both event producers and event consumers. Event producers are entities that detect an event, and indicate that the event has occurred. Event consumers are entities that need to know the event has occurred; they may be involved in processing the event or they may simply be affected by the event. Event consumers typically operate by monitoring a “messaging bus” or “streaming platform” such as Apache Kafka™, which carries event notifications generated by event producers. The benefit of an event-driven architecture is that it enables large numbers of event producers and event consumers to efficiently exchange information in near real-time.

Events tell a story about actions associated with a user or object inside of an application. Hence, events can be quite valuable because they facilitate tracking various activities associated with a user or object. This makes it possible to: upsell to the user, mitigate arising problems for the user, to attract more or fewer of a specific kind of user and to influence certain type of user activity. Moreover, by storing events that are associated with a user, we can perform segmentation operations involving the events. For example, we may want to identify a specific subset of users that have done A but not B within time interval T.

As event-driven computing systems become more widely used, event storage continues to grow, which makes it increasingly more challenging to store the events. Because of limited storage resources, it is not economically feasible to store all of the events in expensive rapidly accessible storage. In practice, some of the events need to be deleted, compressed, or moved to long-term storage. Also note that some events are more important than others. For example, for an e-commerce website, sign-up and check-out events are generally more important than page-view events. However, it is typically difficult to weed out the less-important events. One solution to this problem is to associate a time-to-live (TTL) value with each event, and then expire events based on their TTL values. However, this will not work for events that occur at the start of a customer's relationship and remain valuable throughout the customer's lifetime, such as a sign-up event, an add-subscription event and an enroll-in-trial event. For example, if a user has signed up for an application and has not accessed the application for 90 days, it may be worthwhile to reach out to the user to see if they have encountered a problem in using the application.

Hence, what is needed is a technique for allocating the events to different classes of storage based on the importance of the events to facilitate subsequent query operations involving the events in an event-driven computing system.

### SUMMARY

The disclosed embodiments relate to a system that manages how events are stored and retrieved in an event-driven computing system. During operation, the system obtains an event from a primary events table in the event-driven computing system, wherein the event is associated with a specific event type such as sign-up. Next, the system calculates an importance score for the event based on a rarity of the specific event type and an age of the event. If the importance score falls below a threshold, the system moves the event to a secondary events table, wherein the primary events table is provisioned with superior throughput capacity than the secondary events table, whereby the primary events table facilitates faster queries than the secondary events table.

In some embodiments, the importance score for the event is additionally calculated based on a user-specified importance factor for the event.

In some embodiments, the system additionally enables a user to specify importance factors for different event types.

In some embodiments, the importance score is computed based on a rarity factor, wherein the rarity factor is computed by dividing a total number of events by a number of events of the specific event type.

In some embodiments, the importance score is computed based on an age factor, which is proportionate to one divided by an age of the event.

In some embodiments, the operations are performed by a compaction worker in the event-driven computing system.

In some embodiments, the system additionally performs one or more queries on events in the primary events table to track activities associated with one or more users in the event-driven computing system.

In variations on these embodiments, the one or more queries are also performed on events in the secondary events table.

In some embodiments, the system additionally selects events based on associated event importance scores, and creates an event-related view, which is presented to a user through a user interface.

In some embodiments, the event-driven computing system implements a help center and an associated ticketing system.

In some embodiments, events associated with the ticketing system include one or more of the following: a ticket-creation event; a ticket-updated event; a ticket-solved event; a ticket-deleted event; a user-created event; a user-updated event; a user-deleted event; an account-created event; an account-updated event; an account-deleted event; a subscription-created event; a subscription-updated event; a subscription-deleted event; a help-center-article-published event; a help-center-article-updated event; and a help-center-article-deleted event.

In some embodiments, a relative rarity factor threshold will be used to determine which events will be retrieved for the application, thereby facilitating a better user experience by minimizing the noisy and unimportant events.

### BRIEF DESCRIPTION OF THE FIGURES

FIG. 1 illustrates a computing environment including an application and an associated ticketing system in accordance with the disclosed embodiments.

FIG. 2 illustrates an exemplary event-driven computing system in accordance with the disclosed embodiments.

FIG. 3 illustrates an exemplary screen for a customer-service representative in accordance with the disclosed embodiments.

FIG. 4 presents a flow chart illustrating operations performed by an event-driven computing system in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

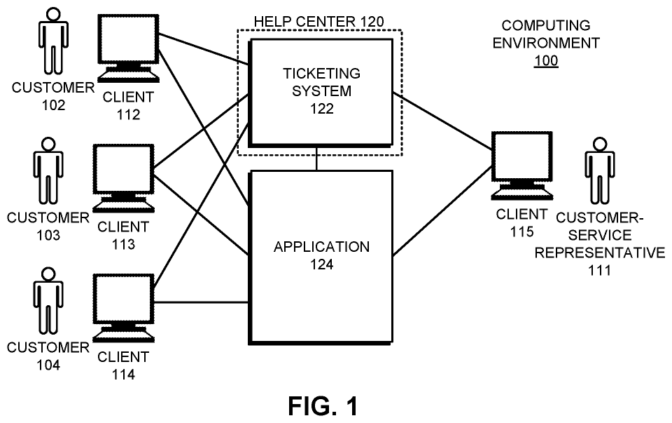

FIG. 1 illustrates an exemplary computing environment 100 in which the event-driven computing system operates. Computing environment 100 includes an application 124 and ticketing system 122 in accordance with the disclosed embodiments. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help center 120 to obtain help in dealing with issues, which can include various problems and questions. For example, a user of accounting software may need help in using a feature of the accounting software, or a customer of a website that sells sporting equipment may need help in cancelling an order that was erroneously entered. This help may be provided by a customer-service representative 111 who operates a client computer system 115 and interacts with customers 102-104 through help center 120. This help may also comprise automatically suggested helpful articles that the customer can read to hopefully resolve the problem or question. Note that customer-service representative 111 can access application 124 (either directly or indirectly through help center 120) to help resolve an issue.

In some embodiments, help center 120 is not associated with computer-based application 124, but is instead associated with another type of product or service that is offered to a customer. For example, help center 120 can provide assistance with a product, such as a television, or with a service such as a package-delivery service.

Help center 120 organizes customer issues using a ticketing system 122, which generates tickets to represent each customer issue. Ticketing systems are typically associated with a physical or virtual “help center” (or “help desk”) for resolving customer problems. Note that, although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

Many of the operations performed by help center 120 are controlled by an event-driven architecture, which is described in more detail below. Note that the technique for assigning events to different classes of storage, which is implemented in the disclosed embodiments, can be applied in different event-driven computing systems, and is not meant to be limited to a help center or a ticketing system.

### Event-Driven Computing System

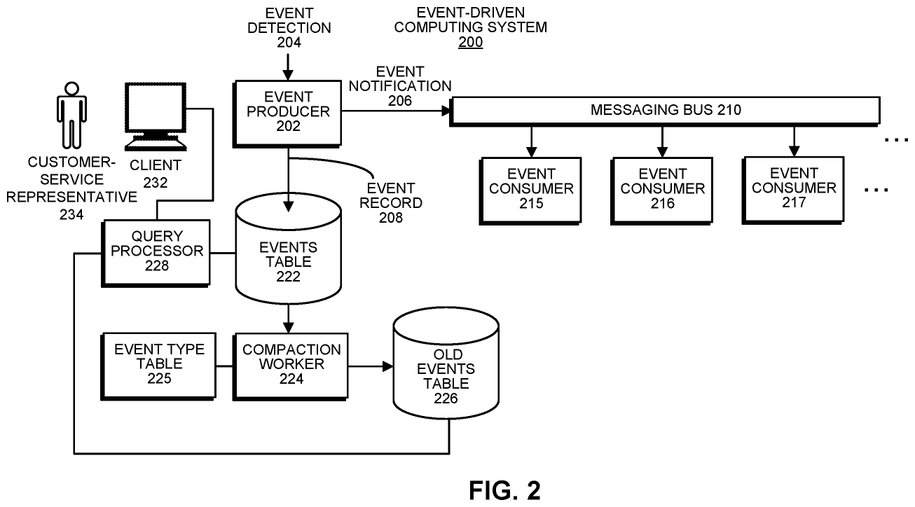

FIG. 2 illustrates an exemplary event-driven computing system 200 in accordance with the disclosed embodiments. As mentioned above, an event-driven computing system includes both event producers, such as event producer 202, and event consumers 215-217. Event producers are entities, such as applications or software modules, which detect an event, and signal that the event has occurred. Event consumers 215-217 are entities that need to know the event has occurred; they may be involved in processing the event or they may simply be affected by the event. Event consumers 215-217 typically operate by monitoring a “messaging bus” or “streaming platform,” such as Apache Kafka™, which carries event notifications generated by event producers. In general, the term “messaging bus” can refer to any type of streaming platform or bus that can carry event notifications, and is not limited to a specific streaming platform, such as Apache Kafka™.

As illustrated in FIG. 2, event-driven computing system 200 includes an event producer 202, which is a programming component that detects an event 204. (In general, the detected event can include any type of hardware-related or software-related occurrence, which can affect the execution of any component or system associated with event producer 202 and event consumers 215-217.) In response to the event detection 204, event producer 202 writes an event record 208, to an events table 222. Event producer 202 also writes a corresponding event notification 206 to a messaging bus 210. The published event notification subsequently propagates through messaging bus 210, which enables it to be received by event consumers 215-217.

In order to reduce the costs involved in storing events, a compaction worker 224 analyzes events stored in events table 222, and selectively moves some of the events to old events table 226. Note that events table 222 is provisioned with superior throughput capacity (in terms of read capacity units and write capacity units) than the old events table 226. This means that the events table 222 can facilitate faster queries than the old events table 226. However, this superior provisioning comes at a cost because cloud-storage providers charge significantly more for storage with superior throughput capacity. This means moving events from events table 222 to old events table 226 can significantly reduce event storage costs, which makes it practical to store large numbers of events to facilitate tracking associated activities of users.

Compaction worker 224 selects events to be moved to old events table 226 based on an event importance score, which can be computed based on a number of factors, including: a rarity of the event type; an age of the event; and a user-specified importance factor for the event. For example, the importance score for a specific event can be computed using the following formula for an event of a specific type,

$$\text{Score(event)} = log ( \frac{\text{total number of events}}{\text{Age(number events of specific type)}} ) \times W ,$$

wherein “Age” is the age of the event in years, and W is a user-specified importance factor for the event. Note that the “total number of events” divided by the “number of events of specific type” comprises a rarity factor, which becomes larger if the specific type of event occurs less often in comparison to the total number of events, and becomes smaller if the specific type of event is more common. Also, 1/Age comprises an age factor, which becomes smaller as an event ages. This is consistent with the fact that older events tend to be less important than newer events as predictors of future user behavior.

Finally, the user-specified importance factor W enables a user to assign a weight to a specific event. For example, W can range from 0 to 10 with a default value of one, wherein a customer can set this value for all of their event types. For example, a user who manages an e-commerce website can set a higher weight for a check-out event or an add-to-cart event than other less important events, such as page-view events. The user can also set W to 0 for a “noisy” event that they do not care about, which means the event importance score will also be 0. Note that all of the above listed scoring factors can be scoped to a specific customer account. Also note that compaction worker 224 can keep track of parameters for different types of events by storing records for the different types of events in an event type table 225.

During operation, compaction worker 224 compares the importance score for an event against a threshold value to determine whether to move the event to old events table 226. If the importance score falls below the threshold value, the associated event is moved to old events table 226. To achieve additional savings, compaction worker 224 can be run more frequently and the threshold value can be increased. Also, if it is necessary to retain a specific type of event in events table 222 for compliance-related reasons, the system can mark all events of the specific type to be skipped by compaction worker 224.

Event-driven computing system 200 also supports query operations involving events. As illustrated in FIG. 2, a query processor 228 can perform various queries on events located in events table 222, for example to facilitate segmentation operations associated with the events. Results of these query operations can be presented to a customer-service representative 234 through a client 232. Note that query processor 228 can also access events stored in old events table 226, although the inferior throughput capacity of old events table 226 means that the associated query operations will not be as fast.

### User Interface

The above-described event importance score can be used for other purposes in addition to making decisions about assigning events to storage. For example, the importance score can be used to select specific events to be displayed to a user. Note that there is typically little value in allowing a user to scan a raw listing of events because the more-important events tend to get drowned out by more-common noisy events. For example, a large percentage of events generated by an e-commerce website are page-view events. This means a user will have a hard time finding occasional important events, such as account-creation events, amongst hundreds of page-view events.

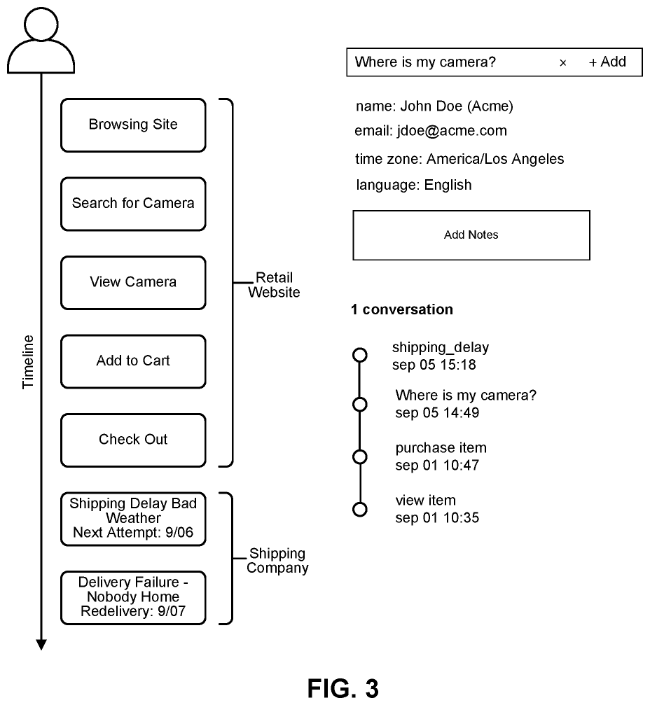

To remedy this problem, the event importance score can be used to select events to be presented to a user. For example, FIG. 3 illustrates an exemplary user-interface screen for a customer-service representative. In this exemplary screen, a customer of an e-commerce website who recently purchased a camera has generated a ticket by asking the question “Where is my camera?” The customer-service representative, who is speaking to the customer, is presented with the user-interface (UI) screen, which provides a timeline of important events associated with the camera purchase. (Note that this timeline integrates events associated with both a retail website and a shipping company.) By viewing this timeline, the customer-support representative can rapidly determine what happened to the camera and can let the customer know when to expect the camera. Note that this would not be possible if the UI simply displayed a raw listing of events to the customer-service representative, because the important events would be hard to pick out of hundreds of less-important noisy events.

### Creating and Event-Related View

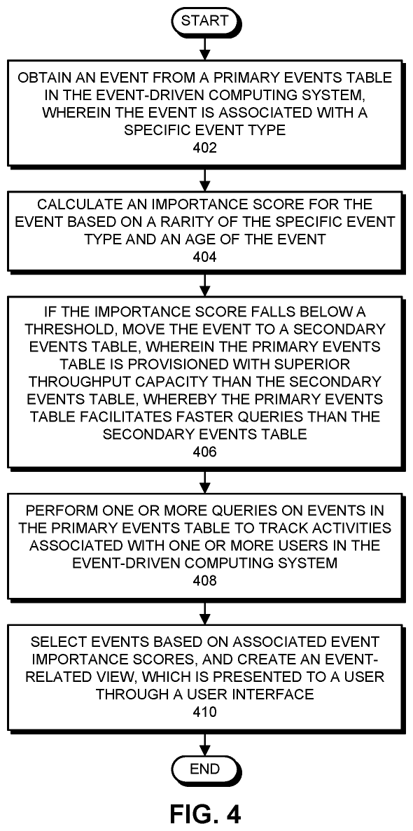

FIG. 4 presents a flow chart illustrating operations performed by an event-driven computing system in accordance with the disclosed embodiments. During operation, the system obtains an event from a primary events table in the event-driven computing system, wherein the event is associated with a specific event type (step 402). Next, the system calculates an importance score for the event based on a rarity of the specific event type and an age of the event (step 404). If the importance score falls below a threshold, the system moves the event to a secondary events table, wherein the primary events table is provisioned with superior throughput capacity than the secondary events table, whereby the primary events table facilitates faster queries than the secondary events table (step 406). Next, the system performs one or more queries on events in the primary events table to track activities associated with one or more users in the event-driven computing system (step 408). The system also selects events based on associated event importance scores, and creates an event-related view, which is presented to a user through a user interface (step 410).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for managing how events are stored in an event-driven computing system, comprising:
obtaining an event from a primary events table in the event-driven computing system, wherein the event is associated with a specific event type;
calculating an importance score for the event based on a rarity of the specific event type and an age of the event; and
if the importance score falls below a threshold, moving the event to a secondary events table, wherein the primary events table is provisioned with superior throughput capacity than the secondary events table, whereby the primary events table facilitates faster queries than the secondary events table.

2. The method of claim 1, wherein the importance score for the event is additionally calculated based on a user-specified importance factor for the event.

3. The method of claim 2, wherein the method further comprises enabling a user to specify importance factors for different event types.

4. The method of claim 1, wherein the importance score is computed based on a rarity factor, wherein the rarity factor is computed by dividing a total number of events by a number of events of the specific event type.

5. The method of claim 1, wherein the importance score is computed based on an age factor, which is proportionate to one divided by an age of the event.

6. The method of claim 1, wherein the method is performed by a compaction worker in the event-driven computing system.

7. The method of claim 1, wherein the method further comprises performing one or more queries on events in the primary events table to track activities associated with one or more users in the event-driven computing system.

8. The method of claim 7, wherein the one or more queries are also performed on events in the secondary events table.

9. The method of claim 1, wherein the method further comprises:
selecting events based on associated event importance scores; and
creating an event-related view, which is presented to a user through a user interface.

10. The method of claim 1, wherein the event-driven computing system implements a help center and an associated ticketing system.

11. The method of claim 10, wherein events associated with the ticketing system include one or more of the following:
a ticket-creation event;
a ticket-updated event;
a ticket-solved event;
a ticket-deleted event;
a user-created event;
a user-updated event;
a user-deleted event;
an account-created event;
an account-updated event;
an account-deleted event;
a subscription-created event;
a subscription-updated event;
a subscription-deleted event;
a help-center-article-published event;
a help-center-article-updated event; and
a help-center-article-deleted event.

12. A non-transitory computer-readable storage medium storing instructions that when executed by a computer cause the computer to perform a method for managing how events are stored in an event-driven computing system, the method comprising:
obtaining an event from a primary events table in the event-driven computing system, wherein the event is associated with a specific event type;
calculating an importance score for the event based on a rarity of the specific event type and an age of the event; and
if the importance score falls below a threshold, moving the event to a secondary events table, wherein the primary events table is provisioned with superior throughput capacity than the secondary events table, whereby the primary events table facilitates faster queries than the secondary events table.

13. The non-transitory computer-readable storage medium of claim 12, wherein the importance score for the event is additionally calculated based on a user-specified importance factor for the event.

14. The non-transitory computer-readable storage medium of claim 13, wherein the method further comprises enabling a user to specify importance factors for different event types.

15. The non-transitory computer-readable storage medium of claim 12, wherein the importance score is computed based on a rarity factor, wherein the rarity factor is computed by dividing a total number of events by a number of events of the specific event type.

16. The non-transitory computer-readable storage medium of claim 12, wherein the importance score is computed based on an age factor, which is proportionate to one divided by an age of the event.

17. The non-transitory computer-readable storage medium of claim 12, wherein the method is performed by a compaction worker in the event-driven computing system.

18. The non-transitory computer-readable storage medium of claim 12, wherein the method further comprises performing one or more queries on events in the primary events table to track activities associated with one or more users in the event-driven computing system.

19. The non-transitory computer-readable storage medium of claim 18, wherein the one or more queries are also performed on events in the secondary events table.

20. The non-transitory computer-readable storage medium of claim 12, wherein the method further comprises:
selecting events based on associated event importance scores; and
creating an event-related view, which is presented to a user through a user interface.

21. The non-transitory computer-readable storage medium of claim 12, wherein the event-driven computing system implements a help center and an associated ticketing system.

22. The non-transitory computer-readable storage medium of claim 21, wherein events associated with the ticketing system include one or more of the following:
a ticket-creation event;
a ticket-updated event;
a ticket-solved event;
a ticket-deleted event;
a user-created event;
a user-updated event;
a user-deleted event;
an account-created event;
an account-updated event;
an account-deleted event;
a subscription-created event;
a subscription-updated event;
a subscription-deleted event
a help-center-article-published event;
a help-center-article-updated event; and
a help-center-article-deleted event.

23. A system that stores events in an event-driven computing system, comprising:
at least one processor and at least one associated memory; and
a storage mechanism, which executes on the at least one processor, wherein during operation, the storage mechanism:
obtains an event from a primary events table in the event-driven computing system, wherein the event is associated with a specific event type;
calculates an importance score for the event based on a rarity of the specific event type and an age of the event; and
if the importance score falls below a threshold, moves the event to a secondary events table, wherein the primary events table is provisioned with superior throughput capacity than the secondary events table, whereby the primary events table facilitates faster queries than the secondary events table.

24. The system of claim 23, wherein the importance score for the event is additionally calculated based on a user-specified importance factor for the event.

25. The system of claim 23, wherein the importance score is computed based on a rarity factor, wherein the rarity factor is computed by dividing a total number of events by a number of events of the specific event type.

26. The system of claim 23, wherein the importance score is computed based on an age factor, which is proportionate to one divided by an age of the event.

27. The system of claim 23, wherein the storage mechanism comprises a compaction worker in the event-driven computing system.

28. The system of claim 23, further comprising a query mechanism that performs one or more queries on events in the primary events table to track activities associated with one or more users in the event-driven computing system.

29. The system of claim 23, further comprising a display mechanism, which:
selects events based on associated event importance scores; and
uses the selected events to create an event-related view, which is presented to a user through a user interface.
